(19) United States
(12) Patent Application Publication
(10) Pub. No.: US 2024/0359553 A1
(43) Pub. Date: Oct. 31, 2024

(54) ICE SCRATCHING DEVICE FOR SNOWMOBILES AND RELATED METHODS

(71) Applicant: Marcial DESMARAIS, Pierreville (CA)

(72) Inventor: Marcial DESMARAIS, Pierreville (CA)

(21) Appl. No.: 18/382,163

(22) Filed: Oct. 20, 2023

Related U.S. Application Data
(60) Provisional application No. 63/418,853, filed on Oct. 24, 2022.

(51) Int. Cl. B60K 11/02; B62D 55/092; B62M 27/02

(52) U.S. Cl. CPC B60K 11/02; B62D 55/092; B62M 27/02

(57) ABSTRACT

A scratching device and a method for scratching the icy surface for a snowmobile are disclosed. The scratching device, or ice scratcher, comprises a securing portion for laterally attaching the device towards the snowmobile; a scratching portion for scratching an icy surface when the snowmobile is travelling on the icy surface, thereby creating a stream of ice particles; and an orienting component cooperating with the scratching portion for directing the stream of ice particles towards the components of the snowmobile for cooling the components when the snowmobile is travelling. The scratching device may therefore direct, via the orienting component, a stream of ice particles toward the snowmobile components, e.g., for lubrication and cooling. A method of installing the scratching device on the snowmobile is also disclosed.

### CROSS-REFERENCE TO RELATED APPLICATIONS

The present application claims priority of U.S. provisional application No. 63/418,853 filed on Oct. 24, 2022, the content of which is incorporated herein by reference.

### TECHNICAL FIELD

The present invention generally relates to ice scratching devices or ice scratchers. More particularly, the invention relates to ice scratchers for snowmobiles.

### BACKGROUND

Various components of a snowmobile are cooled and lubricated during operation on loose snow by streams of snow sprayed to the various components during normal operation. However, when a snowmobile operates on hard packed snow or on an icy surface, there may be no spray at all and an additional component is required in order to alleviate that problem. Unfortunately, current solutions are only partially successful. An improved solution is described herein.

### SUMMARY

The shortcomings are generally mitigated by the scratching device as described herein for a snowmobile.

According to a first aspect, it is disclosed a scratching device for a snowmobile, the device being configured to be operatively affixed to a securing element for laterally attaching the device towards the snowmobile. The scratching device comprises a scratching element for scratching an icy surface when the snowmobile is travelling on the icy surface, thereby creating a stream of ice particles, the scratching element comprising: a contacting head for contacting the ice, and an orienting portion adjacent the contacting head and configured to be affixed to the securing element, wherein the orienting portion cooperates with the contacting head for orienting the stream of ice particles towards components the snowmobile that need to be cooled, and maximizing as such an amount of ice sent towards the components of the snowmobile when the snowmobile is travelling.

According to a preferred embodiment, the contacting head and the orienting portion are permanently secured to one another.

According to a preferred embodiment, the contacting head is removable from the scratching element.

According to a preferred embodiment, the contacting head is made of a first material and the scratching portion is made of a second material, the first material being harder than the second material.

According to a preferred embodiment, when the securing element is a flexible wire affixed at one end to the snowmobile and at the opposite end to the scratching device, the scratching element almost forms a triangular shape with a triangular surface and having: a first edge configured to be aligned and affixed with the securing portion; a second edge opposite the securing portion and forming a ridge extending perpendicularly from the triangular surface for defining the orienting portion; a third edge extending from the securing portion, and a recess defined at the junction of the second and third edges and configured for receiving and maintaining the contacting head therein. Preferably, the ridge forms a curved outside surface along the second edge, the orienting portion being angled towards the snowmobile vis-à-vis the icy surface.

According to a preferred embodiment, the scratching device is hingely secured to the securing element towards the snowmobile for allowing rotation of the scratching device along a longitudinal plane of the snowmobile.

According to another preferred embodiment, when the securing element is a coil affixed at one end to the snowmobile and at the opposite end to the scratching device, the scratching element has a longitudinal tubular shape with: a first end configured to be aligned and affixed with the securing portion; a second end opposite the first end and comprising the contacting head; and a gutter adjacent the second end and forming the orienting portion.

According to a preferred embodiment, the first end forms a tube configured to insert the opposite end of the coil therein.

According to a preferred embodiment, the opposite end of the coil is affixed to the tube by welding or gluing.

According to a preferred embodiment, the tube defined a lateral threaded hole, the opposite end of the coil being affixed to the tube by screwing a screw in the hole.

The scratching device of claim 9, wherein the opposite end of the coil is affixed to the tube by pressing portions of the tube towards the opposite end.

According to a preferred embodiment, the opposite end of the coil is affixed to another tube configured to be secured to the tube of the scratching device by screwing.

According to a preferred embodiment, the tube is curved.

According to a preferred embodiment, the coil is a double coil.

According to a preferred embodiment, the contacting head is misaligned with the gutter of an angle, preferably an angle of about 45 degrees.

According to a preferred embodiment, the coil has one end to be affixed at to a frame of the snowmobile and at an opposite end connected to the scratching device, the one end forms a boucle or longitudinal loop configured for accepting a fixing pin of the fixing element therein for blocking a rotation of the coil around a screw to the fixing element when the coil is screwed to the frame through an orifice of the fixing element.

According to a preferred embodiment, the snowmobile comprises a longitudinal axis defined by a rear end and a front end of the snowmobile such that the scratching device is positioned behind the securing portion when the snowmobile is in forward movement and positioned in front of the securing portion when the snowmobile is in rearward movement. Although not shown in the drawings, inversely the scratching device may be positioned in front the securing portion when the snowmobile is in forward movement and positioned behind of the securing portion when the snowmobile is in rearward movement

According to a second aspect, it is disclosed a method for cooling components of a moving snowmobile. The method comprises, while the snowmobile is travelling on an icy surface, scratching the surface with a scratching device, thereby creating a stream of ice particles, the stream of icy particles being controllably directed towards the components by an orienting portion of the scratching device.

According to a second aspect, it is disclosed a kit for fixing a scratching device, such as the one disclosed herein, to a frame of a snowmobile, comprising at least one double-coil spring and a fixing element, such as those disclosed herein in the present description in reference to FIGS. 12 to 18.

According to a preferred embodiment, the method comprises rotating an attachment between the snowmobile and the scratching device along a longitudinal plane of the snowmobile according to a moving direction of the snowmobile.

According to another embodiment, the method comprises adjusting an angle between the orienting portion of the scratching device and the snowmobile according to desired components to be cooled, expected speed of the snowmobile and expected conditions of the icy surface, thereby controllably directing the stream of icy particles towards desired components to be cooled.

According to a third aspect, it is disclosed a method of installing a scratching device on a snowmobile. The method comprises laterally attaching a securing portion of the scratching device towards the snowmobile, adjustably rotating the scratching device along a longitudinal plane of the snowmobile according to an expected movement direction of the snowmobile, and adjusting an angle between an orienting component of the scratching device and the snowmobile according to desired components to be cooled, expected speed of the snowmobile and expected conditions of the icy surface.

Advantageously, the cooperation between the orienting portion and the contacting head allows orienting the stream of ice or snow particles towards components the snowmobile that need to be cooled, while maximizing the amount of ice or snow sent towards the components of the snowmobile when the snowmobile is travelling

Other and further aspects and advantages of the present invention will be better understood upon the reading of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1A illustrates a side view of an ice scratching device according to a first preferred embodiment, secured towards a snowmobile in a first position when the snowmobile is going forward;

FIG. 1B illustrates a side view of an ice scratching device according to a first preferred embodiment, secured towards a snowmobile in a second position when the snowmobile is going backwards;

FIG. 2A illustrates a side view (left view) and a front view (right view) an ice scratching device according to the first preferred embodiment with the securing element and scratching portion removed;

FIG. 2B illustrates shapes of the scratching portion according to different preferred embodiments;

FIG. 3 illustrates different views of the ice scratching device according to the first preferred embodiment with the securing element removed (left view) with (A) front lateral isomeric view, (B) back lateral isomeric view, (C) a top plan view, (D) a side plan view and (E) a front plan view;

FIG. 4 illustrates different views of the ice scratching device according to the first preferred embodiment with (A) a back lateral isomeric view, (B) a side plan view and (C) a bottom plan view;

FIG. 5A illustrates a side view of an ice scratching device according to a second preferred embodiment, secured towards a snowmobile in a first position when the snowmobile is going forward;

FIG. 5B illustrates a side view of an ice scratching device according to a second preferred embodiment, secured towards a snowmobile in a second position when the snowmobile is going backwards;

FIG. 6 illustrates different views of the ice scratching device according to the second preferred embodiment with the scratching portion aligned with the scooping portion: with (A) back lateral isomeric view, (B) top plan view, (C) lateral view, (D) cut view along A-A in view C;

FIG. 7 illustrates different views of the ice scratching device according to the second preferred embodiment with the scratching portion rotated related to the scooping portion with: (A) back lateral isomeric view, (B) top view, (C) lateral view, and (D) cut view along D-D in view C;

FIG. 8 illustrates different views of the ice scratching device according to the second preferred embodiment with the scratching portion aligned with the scooping portion, the connecting portion comprising threaded hole for attachment: with (A) back lateral isomeric view, (B) top plan view, (C) lateral view, (D) cut view along A-A in view C;

FIG. 9 illustrates different views of the ice scratching device according to the second preferred embodiment with the scratching portion aligned with the scooping portion, the connecting portion comprising compressed portions for attachment: with (A) back lateral isomeric view, (B) top plan view, (C) lateral view, (D) cut view along A-A in view C;

FIG. 10 illustrates different views of the ice scratching device according to the second preferred embodiment with the scratching portion aligned with the scooping portion, the connecting portion comprising threaded portions for attachment: with (A) back lateral isomeric view, (B) top plan view, (C) lateral view, (D) cut view along A-A in view C;

FIG. 11 illustrates different views of the ice scratching device according to the second preferred embodiment with the scratching portion aligned with the scooping portion, the connecting portion for attachment being curved: with (A) back lateral isomeric view, (B) top plan view, (C) lateral view, (D) back view;

FIG. 12 is a picture showing a section of a frame of a snowmobile configured to receive the ice scratching device, according to a preferred embodiment;

FIG. 13 is a picture showing a section of a frame of a snowmobile where the ice scratching device is fixed and a first fixing element with (A) front view and (B) bottom inclined view, according to a preferred embodiment;

FIG. 14 are closer views of the first fixing illustrated on FIG. 12 with a fixing bolt, with (A) front isomeric view and (B) lateral inclined view, according to a preferred embodiment;

FIG. 15 are closer views of the first fixing illustrated on FIG. 12 partially affixed tot eh frame with a fixing bolt, with (A) front view and (B) lateral isomeric view, according to a preferred embodiment;

FIG. 16 are pictures showing a section of the frame of a snowmobile where the ice scratching device is affixed using a double coil spring in the scratching position, with (A) a side view and (B) a side isomeric view, according to a preferred embodiment;

FIG. 17 are closer views of the double coil spring in the scratching position illustrated on FIG. 16, with (A) top view and (B) side view, according to a preferred embodiment;

FIG. 18A is a picture showing a section of the frame of a snowmobile where the ice scratching device is affixed using a double coil spring in the non-scratching position;

FIG. 18B is a picture showing in detail the longitudinal fixing loop of a double coil spring in the non-scratching position according to a preferred embodiment;

FIG. 19 is a flowchart of a method for cooling components of a moving snowmobile, according to a preferred embodiment; and

FIG. 20 is a flowchart of a method for installing a scratching device on a snowmobile, according to a preferred embodiment.

### DETAILED DESCRIPTION

In order to cool and/or lubricate components of a snowmobile, ice scratchers may be positioned on each side and deployed onto a frozen surface (ice and/or snow). During operation, the ice scratchers detach snow and/or ice and some of the detached snow and/or ice ends up on the track and slide rails of the snowmobile, which may thereby be cooled and/or lubricated. However, the ice scratchers are largely inefficient and a large portion of the detached snow and/or ice is simply lost. Furthermore, the ice scratchers may not provide enough snow or ice to properly cool and/or lubricate components.

There is thus a need for an improved ice scratcher capable of directing scratched ice particles toward components of the travelling snowmobile to enhance the cooling and lubrication effect of the scratched ice. The lubrication and/or cooling may be useful in order to prevent overheating and premature wear and tear of the snowmobile components.

A novel scratching device for attachment to a snowmobile will be described hereinafter. Although the invention is described in terms of specific illustrative embodiments, it is to be understood that the embodiments described herein are by way of example only and that the scope of the invention is not intended to be limited thereby.

The terminology used herein is in accordance with definitions set out below.

By “about”, it is meant that the value can vary within a certain range depending on the margin of error of the device used to evaluate or measure. A margin of error of 10% is generally accepted.

Current ice scratchers displace ice particles from icy surfaces as the snowmobile is travelling in order to cool and lubricate components of the snowmobile. However, the majority of scratched ice particles never reach the snowmobile components since they are scattered everywhere around the travelling snowmobile. Indeed, only a small portion of the scratched ice becomes useful for cooling and lubrication.

Exemplary scratching devices for a snowmobile, in accordance with the teachings of the present invention, will be described herein. An exemplary method of installing a scratching device on a snowmobile and an exemplary method for cooling components of a moving snowmobile will also be described.

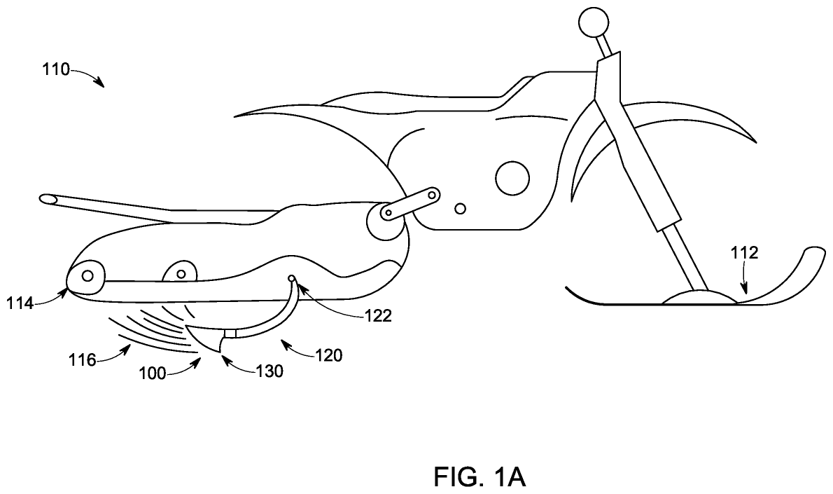

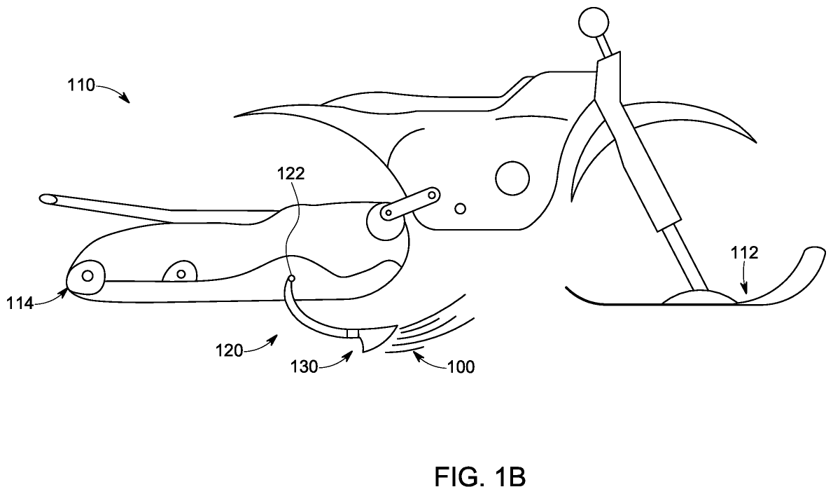

A first embodiment is illustrated on FIGS. 1 to 4 of the drawings, in which FIG. 1 shows an exemplary snowmobile 110. A longitudinal axis of the snowmobile 110 is defined along skis 112 of the snowmobile at a front end thereof and drive tracks and rails 114 reaching at a rear end of the snowmobile 110. Scratching devices 100 are typically positioned on each side of the snowmobile 110, between the front end and the rear end, but skilled persons will recognize that a single device on a single side could be used. The front end and rear end of the snowmobile 110 are defined herein having in mind an expected and most common travel direction of the snowmobile 100 and is used as such throughout the description.

The scratching device 100 secured towards a snowmobile 110 is shown in FIG. 1. The scratching device 100 is configured to be attached to a securing element 120 that may be directly secured to an attachment point 122 on the snowmobile 110 or may be secured to the snowmobile via an interconnecting member (not shown) secured to the attachment point 122. In the first embodiment is illustrated on to FIGS. 1 to 4, the securing element 120 is a wire, such as semi-rigid stranded wire, i.e. preferably protected with a plastic coating or sheath. The scratching device 100 comprises a scratching element 130 for scratching an icy surface when the snowmobile 110 is travelling on the icy surface, thereby creating a stream of ice particles 116.

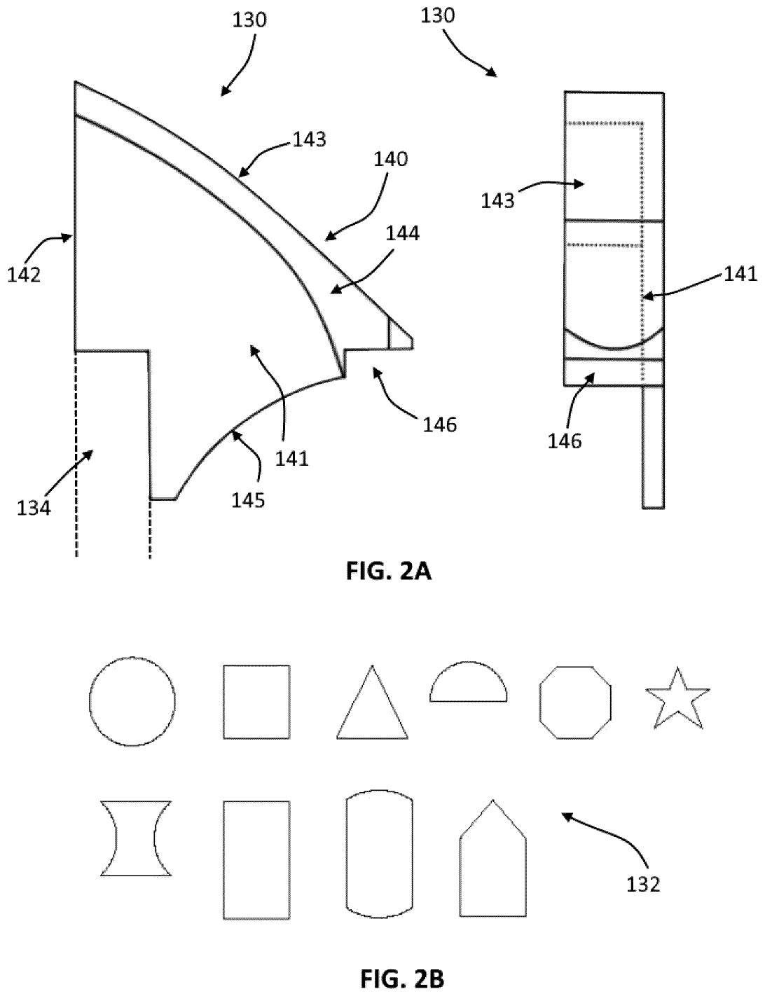

As better illustrated on FIGS. 2 to 4, the scratching element 130 comprises a contacting head 132 for contacting the ice, and an orienting portion 140 adjacent the contacting head and configured to be affixed to the securing element.

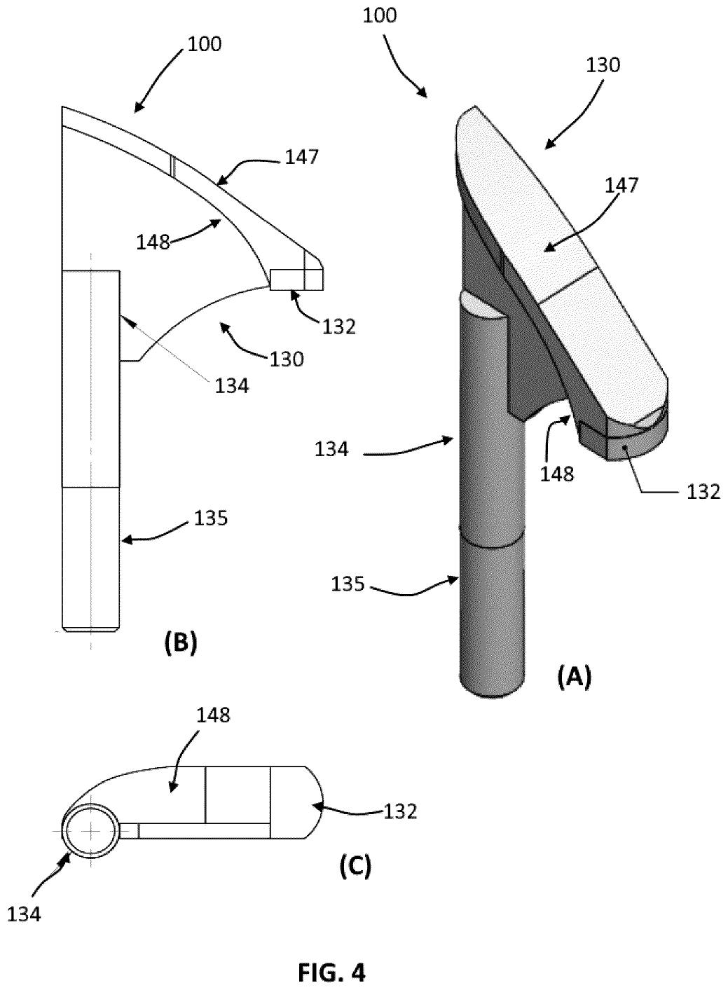

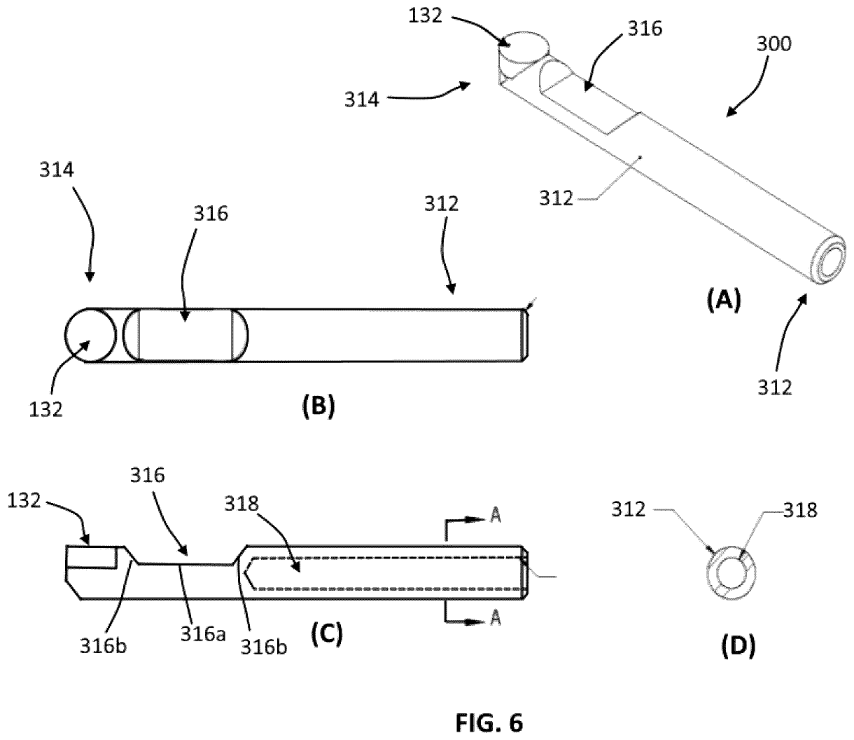

As aforesaid, when the securing element 120 is a flexible wire, such as the one illustrated on FIG. 1, it is affixed at one end 122 to the snowmobile 110 and at the opposite end to the scratching element 130 comprising a securing portion 134, such as the one illustrated on FIG. 4 having a tubular shape. Different types of possible securing portions will be discussed hereafter in reference to the second embodiment and FIGS. 6 to 11.

According to the first embodiment as illustrated on FIGS. 1 to 4, the scratching element 130 forms a triangular-like shape with a triangular-like surface 141 having:
a first edge 142 configured to be aligned and affixed with the securing portion 134;
a second edge 143 opposite the securing portion and forming a ridge 144 extending perpendicularly from the triangular-like surface 141, the ridge 144 cooperating with the triangular-like surface 141 to form the orienting portion 140;
a third edge 145 extending from the securing portion 134 towards the second edge 143, and
a recess 146 defined at the junction of the second and third edges 143, 145 and configured for receiving and maintaining the contacting head 132 therein.

Several different shape of contacting heads 132 are illustrated on FIG. 2B.

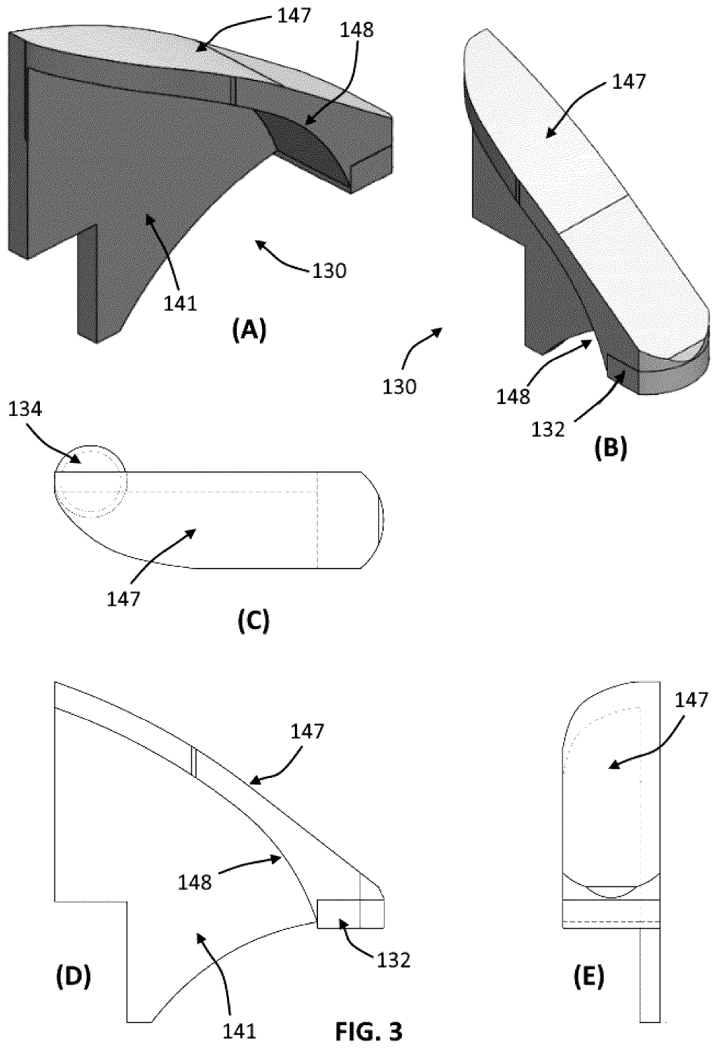

As better visible on FIGS. 3 and 4, the ridge 144 forms a curved outside surface 147 along the second edge, and a curved inside surface 148 adjacent the scratching head, that an be oriented at an angle towards the snowmobile vis-à-vis the icy surface.

The triangular-like surface 141, the ridge 144, preferably a curved ridge, of the orienting portion 140 cooperates with the contacting head 132 for orienting the stream of ice particles towards components the snowmobile that need to be cooled, and for maximizing the amount of ice sent towards the components of the snowmobile when the snowmobile is travelling.

As previously mentioned, the scratching device may or may not be directly secured to the attachment point 122 as the scratching device 100 may further include an interconnecting member (not shown). As an example of the scratching device 100 being directly secured to the snowmobile 110, the attachment point 122 may comprise an inner threaded receiver portion configured to receive a threaded portion of the securing portion 120. Alternatively, an interconnecting member may be secured to the attachment point 122 on the snowmobile 110 from one end and to the securing portion 120 of the scratching device 100 from another end, thereby interconnecting the scratching device 100 to the snowmobile 110. The interconnecting member may present rigidity characteristics for allowing the scratching portion 130 to apply a force directed on the icy surface, thereby displacing enough ice particles for providing the stream of icy particles 116 to be directed by the orienting component 140 to cool and/or lubricate the snowmobile components (e.g., the interconnecting member may comprise a semi-rigid stranded wire). Yet, the interconnecting member may still present flexibility characteristics to allow bending thereof in order, for instance, to get around and/or over obstacles encountered on the icy surface as the snowmobile 110 is traveling. Likewise, the flexibility characteristics allow bending of the interconnecting member when the snowmobile 110 is traveling on harder surfaces (e.g., roads and the likes) thereby diminishing premature wear of the scratching portion 130. Although the semi-rigid stranded wire may function as an interconnecting member, the scratching device 100 may also comprise the semi-rigid stranded wire such that the scratching device 100 is configured to be directly secured to the attachment point 122 on the snowmobile 110. Any suitable interconnecting element may be utilized while remaining within the teachings of the present invention. Variations of interconnecting elements for securing ice scratchers on snowmobiles may be suitable depending on the specific configuration of the securing portion 120 and the model of the snowmobile 110. For example, any kind of suitable semi-rigid shaft may be configured for being secured to a snowmobile from one end and to the securing portion 120 of the scratching device 100 from another end.

Referring to FIG. 1A, the scratching device 100 is secured towards a snowmobile 110 travelling forward. In these conditions, the scratching element 130 of the scratching device 100 is in the forward position as it is rearwardly oriented relative to the attachment point 122. The ice particles 116 are directed towards the drive tracks and rails 114 as well as other components of the snowmobile 110. In this position, the proximity of the scratching element 130 to the drive tracks and rails 114 improves distribution of the ice particles 116 onto components of the snowmobile 110.

Referring to FIG. 1B, the scratching element 130 and orienting component 140 of the scratching device 100 can be forwardly oriented relative to the attachment point 122 in the reverse position when the snowmobile 110 is travelling rearward, as exemplified. Although the scratching device 100 is not as efficient at directing ice particles 116 towards the drive tracks and rails 114 when the scratching portion 130 is forwardly positioned, the scratching device 100 may still provide some cooling and lubricating when travelling rearward, e.g., especially when travelling rearward for long distances and/or at high speeds.

According to a preferred embodiment, the scratching device 100 may be hingely secured to the snowmobile 110 to allow rotation of the scratching device 100 along a longitudinal plane of the snowmobile 110, thereby allowing for changing of a position of the scratching device 110 between the forward and reverse positions.

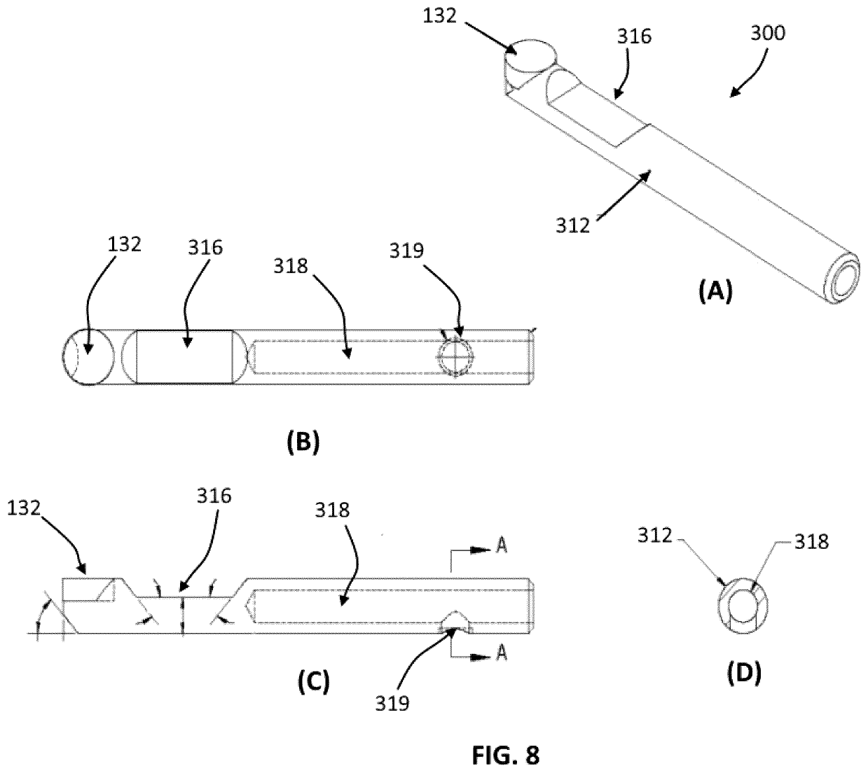

As illustrated on FIG. 4, the scratching device 100 includes a securing portion 134 for laterally attaching the scratching device 100 to the securing element 120. The securing element 120 may include an attaching portion 135 for mating with the securing portion 134 of the ice scratching device 100 forming as such interconnecting members. For instance, the interconnecting members may be secured using respective threaded portions, a hole and nut (such as the illustrated on FIG. 8). For example, the threaded portion 124 may be a ⅜ bolt although different size bolts maybe be used without deviating from the teachings of the present invention. As such, the securing portion 120 may provide a detachably attachable mechanism to make it easier for a user to replace, clean, maintain and/or repair the scratching device 100.

The different components of the scratching device 100 are typically made of any suitable material comprising metal and/or plastic well known in the art. For instance, the components may be made from steel, stainless steel or aluminium, preferably stainless steel. Alternatively, the components may also be made from any form of suitable plastic material. In some instances, a single material may be used for the different components of the scratching device 100.

In other embodiments, different materials may be combined. The scratching element 130 comprises a contacting head 132, which may be harder than the scratching element 130 to prevent wear and tear of the scratching portion 130, especially when the snowmobile 110 is not travelling on an icy surface. Paved or gravel roads are sometimes unavoidable as travel from one icy surface to another is required and even short distances may be sufficient to unduly damage the scratching portion 130. A contact member 132 made of carbide, for example, may help addressing a premature wear problem by providing a scratching portion 130 capable of withstanding harder and rougher surfaces. Moreover, if the contact member 132 is damaged, the scratching device 100 may be removed from the snowmobile 110 and a replacement contacting (such as those illustrated on FIG. 2B) may then be mounted on the scratching element 130.

As illustrated on FIG. 2B, the scratching head 132 may be provided in different shapes and sizes, e.g., in order to address specific needs. The scratching head 132 may for example have a rounded shape, a square shape, a triangle shape, octagon shape, half-moon shape or may have a diamond tip shape. It is to be understood that these shapes are only examples and the scratching head 132 may be provided in additional shapes while still remaining within the teachings of the present invention.

As the snowmobile 110 travels on any icy surface, the scratching device 100 creates a stream of ice particles 116. The orienting portion 140 limits the scattering of the ice particles cooperating with the scratching head 132 for directing the stream of ice particles 116 toward the components of the snowmobile 110.

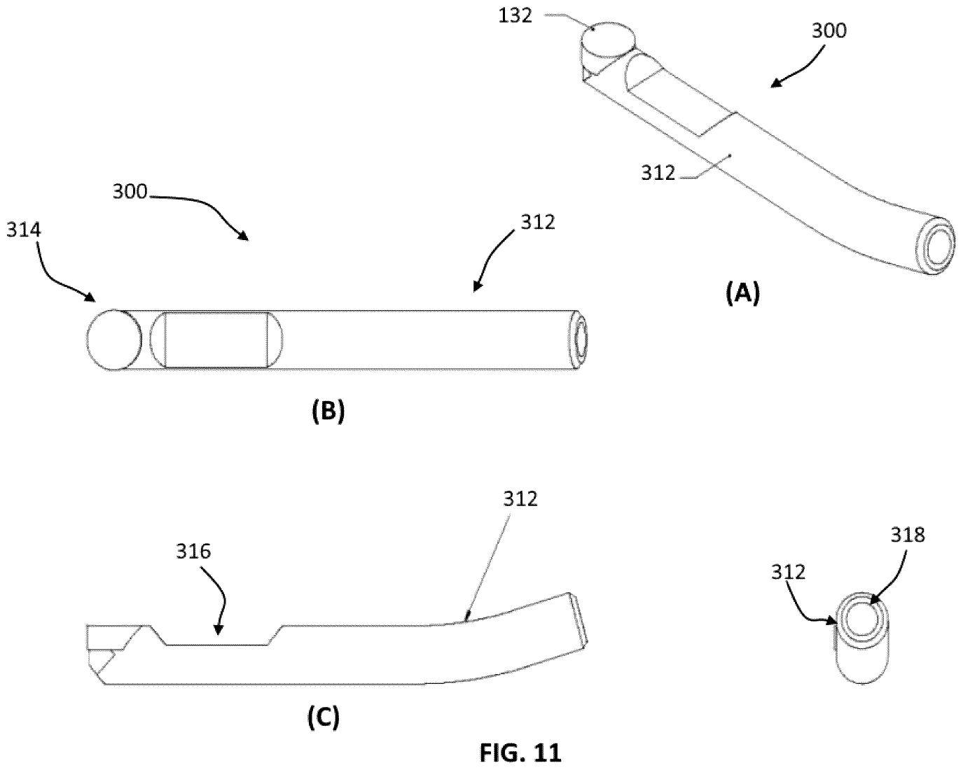

In the depicted example, the orienting portion 140 comprises a flat surface 141. It is to be understood that orienting component 140 can be of different shapes and sizes while still remaining within the teachings found herein. In addition, the securing portion 134 and/or the surface 141 may be curved or otherwise bended, which may be helpful when adapting the scratching device 100 to a specific model of snowmobile. Similar example of a securing portion 134 being bended is depicted on FIG. 11 in relation with the second embodiment disclosed herein after.

The curving or bending of the securing portion 134 and/or the orienting surface 141 may be useful in modifying the contact angle with the icy surface and/or the angle between the orienting portion 140 and the snowmobile 110, which may in turn modify the force exerted on the ice scratcher and modify the stream of ice particles 116 which may improve scattering of the ice particles 116 towards the components of the snowmobile 110. The orienting portion 140 may be fixed by design or may be adjustable, e.g., after installation on a snowmobile 110. In some embodiments, the orienting component 140 can be fixed according to desired components to be cooled, expected speed of the snowmobile 110 and expected conditions of the icy surface for controllably directing the stream of icy particles 116 towards desired components to be cooled. Having the orienting component 140 adjustable may be helpful for adapting to different surface conditions and/or installation on different snowmobile 110.

The orienting portion 140 may be angled towards the snowmobile 110 vis-à-vis the icy surface to maximize ice particles reaching components of the snowmobile 110. The scratching element 130 and the orienting component 140 may be permanently secured to one another by any method well known in the art such as welding. Alternatively, the orienting component 140 may comprise the scratching portion 130 contiguously thereto. For instance, a single stainless steel or plastic component may be shaped as to provide different surfaces which, when combined, perform functions described herein for the scratching portion 130 and the orienting component 140.

A downward force is exerted on the ice scratcher 100, which may be from the gravitational force alone or may be assisted by additional forces, for example, by forces generated by the securing element 120 secured to the snowmobile 110. The downward force may modulated by the speed of the travelling snowmobile 110, the configuration of the securing portion 120 and the configuration of the attachment between the securing portion 120 and the attachment point 122. In contrast, since the icy surface exerts a force in the opposite direction to the downward force, variations of characteristics of the icy surface will affect the opposite force exerted by the icy surface such that different quantities of ice particles are detached. For example, a solid ice surface will exert a greater force on the ice scratcher 100 and will therefore allow smaller quantities of ice particles to be detached compared to a powdery snow surface which exerts a smaller force on the ice scratcher 100 and therefore allow greater quantities of ice particles to be detached. When in use while the snowmobile 110 is travelling forward, the contacting head 132 of the scratching element 130 scratches the icy surface and detaches icy particles therefrom. The icy particles are detached considering the downward force and the movement of the snowmobile 110. The icy particles move in many directions upon detachment. The trajectory of the icy particles that are detached on an interior side of the ice scratcher 100 (i.e., between the ice scratcher 100 and the snowmobile 110) is affected by the orienting component 140 in order to provide the stream of icy particles 116 in a more controlled manner.

More specifically, in the example of FIGS. 2 to 4, the orienting portion 140 comprises a ridge forming an upward curved surface 148 and a substantially flat surface 141 substantially perpendicular to the upward curved surface). As an example, the upward curved surface 148 may have a width and thickness of about ⅜″ and a length of about 2″ 5/16. It is to be understood that these measurements are approximate and may vary according to a specific need. As such, the upward curved surface 148 may have a width ranging between about ⅛″ and 1″ whereas the length may vary between about 1″ and 4″. The fin shape flat portion 144 may have a curved surface of about 2″ 5/16 with a variation of between ½″ and 3″ while the distance between the contacting head 132 and the securing element 120 may be about ½″ although variations between about ½″ and 1″½ may be acceptable within the teachings of the present invention. Moreover, the diameter of the securing element 134 may be about ⅜″ with an acceptable variation of between about ¼″ and ½″ whereas the height of the contacting head 132 may be about ⅜″ with an acceptable variation of between about ⅛″ and 1″. These measurements will be understood as still remaining within the teachings of the present invention as long as the dimensions allow the scratching device to exert its function of scratching an icy surface and directing a stream of ice particles towards components of a snowmobile for cooling the components when the snowmobile is travelling.

When installed on the snowmobile 110, it has been shown that an angle of between about 45° to about 90° between the contacting head 132 and the icy surface is effective. The angle can be defined as the angle created between the contacting head 132 and a direction vector when the snowmobile 110 is traveling. Of course, experimentation may prove that a smaller range is more effective or, conversely, that a broader range is still effective. Such experimentation should not be viewed as excluding those other ranges from the scope of the claims defined herein below. The contacting head 132 terminates upward onto the orienting portion 140, at the intersection between the upward curve surface 147 and the flat surface 141. The icy particles detached by the contacting head 132 are limited in their transverse interior distribution by the surface 141 while being directed upwards by the upward curve surface 148, thereby providing the stream of icy particles 116.

Skilled persons will readily recognize that the perpendicularity between the upward curve 148 and the flat surface 141 is not essential in all embodiments and that the selection of the angle therebetween shall take into consideration the type of distribution desired for the stream of icy particles 116 (e.g., a narrower angle limiting spread of the stream of icy particles 116 while a wider angle would expand the spread. Skilled persons will readily recognize that the length and curvature of the upward curve 148 shown in the figures shall be determined taking into consideration the type of distribution desired for the stream of icy particles 116. More specifically, considering the angle between the ice scratcher 100 and the icy surface, a shorter and/or narrower upward curved surface 148 would increase backward spread and likely limit the upward spread of the stream of icy particles 116 while a longer and/or wider angle would limit the backward spread and likely augment the upward spread). It should also be understood that the direction of the stream of icy particles 116 is influenced by the manner in which the ice scratcher 100 is secured towards the snowmobile 110 and, more specifically, by a rotational angle defined along the longitudinal axis of the ice scratcher 100; a downward angle defined between the longitudinal axis of the ice scratcher 100 and the icy surface as well as a transverse angle defined between the longitudinal axis of the snowmobile 110 and the longitudinal axis of the ice scratcher 100.

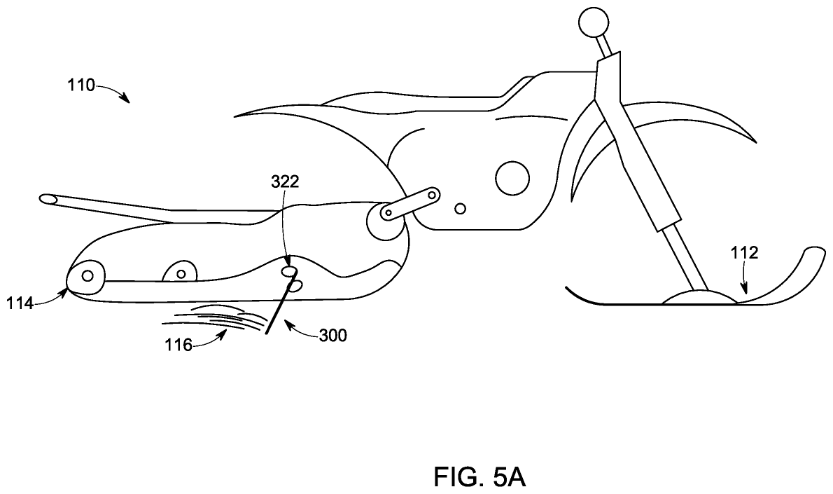

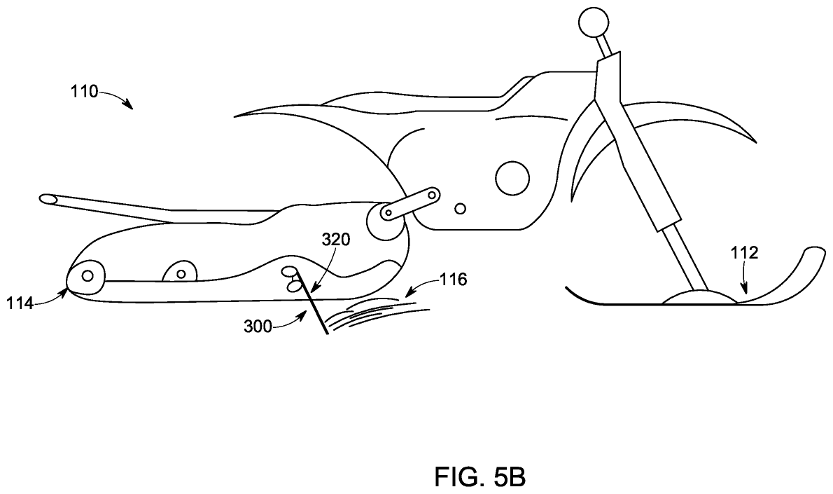

Reference is now concurrently made to FIGS. 5 to 11 in order to describe another exemplary embodiment of a scratching device in accordance with the present invention.

FIGS. 5A and 5B shows scratching device 300 secured towards a snowmobile 110. The scratching device 300 includes a securing element 320 which may be directly secured to an attachment point 322 on the snowmobile 110 or indirectly secured to the attachment point 322 via an interconnecting member (not shown).

In FIG. 5A, the scratching device 300 is secured towards the snowmobile 110 travelling forward, the scratching device 300 being in the forward position and are rearwardly positioned relative to the attachment point 322. The ice particles 116 are directed towards the drive tracks and rails 114 as well as other components of the snowmobile 110. Proximity of the scratching portion 330 to the drive tracks and rails 114 may help improving contact of the ice particles 116 with the components. With reference to FIG. 5B, the scratching element 330 of the scratching device 300 can be forwardly positioned relative to the attachment point 322 in the reverse position when the snowmobile 110 is travelling rearward, as exemplified.

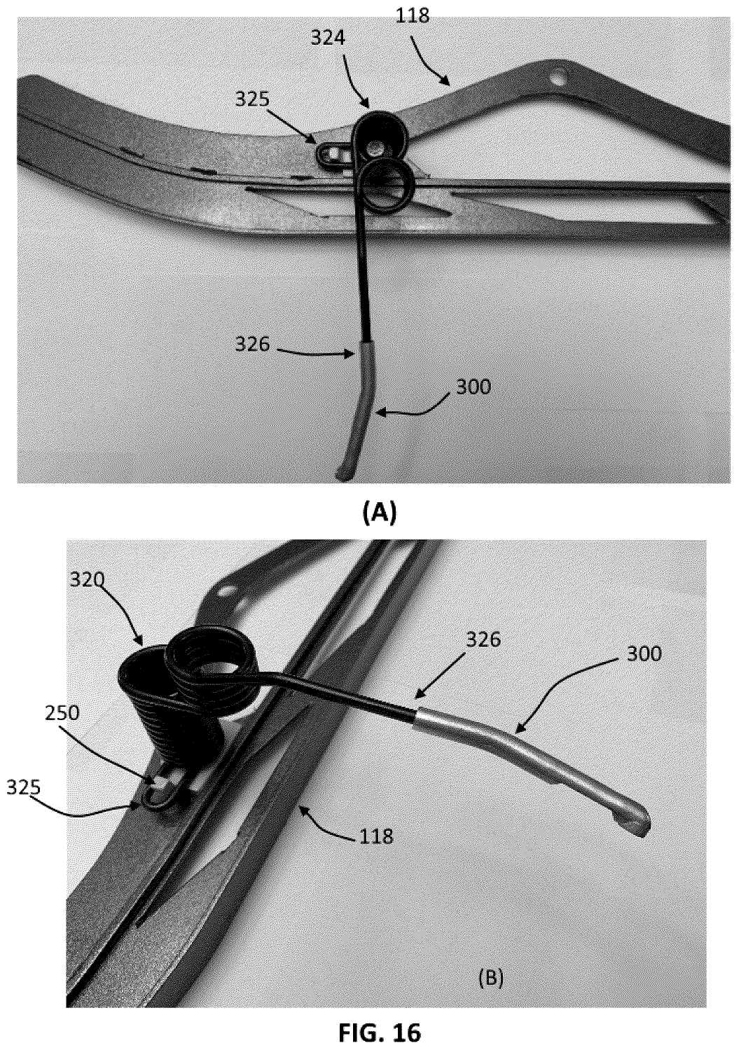

The scratching device 300 as illustrated on FIGS. 6 to 11 is preferably used when the securing element 320 is a coil, or a double-coil such the one illustrated on FIGS. 16 to 18, with one end 324 affixed at to a frame 118 of the snowmobile 110 and at an opposite end 326 connected to the scratching device 300.

According to this second embodiment, the scratching element 310 has a longitudinal tubular shape, such as the one closely described on FIGS. 6 to 11, with:
a first end 312 configured to be aligned and affixed with the securing element 320;
a second end 314 opposite the first end 312 and configured for comprising the contacting head 132; and
a gutter 316 adjacent the second end 314 and forming the orienting portion 340.

As for the first embodiment of the scratching device 100 disclosed in FIGS. 1 to 5, the gutter 316 of the orienting portion 140 cooperates with the contacting head 132 for orienting the stream of ice particles towards components the snowmobile that need to be cooled, and for maximizing the amount of ice sent towards the components of the snowmobile when the snowmobile is travelling.

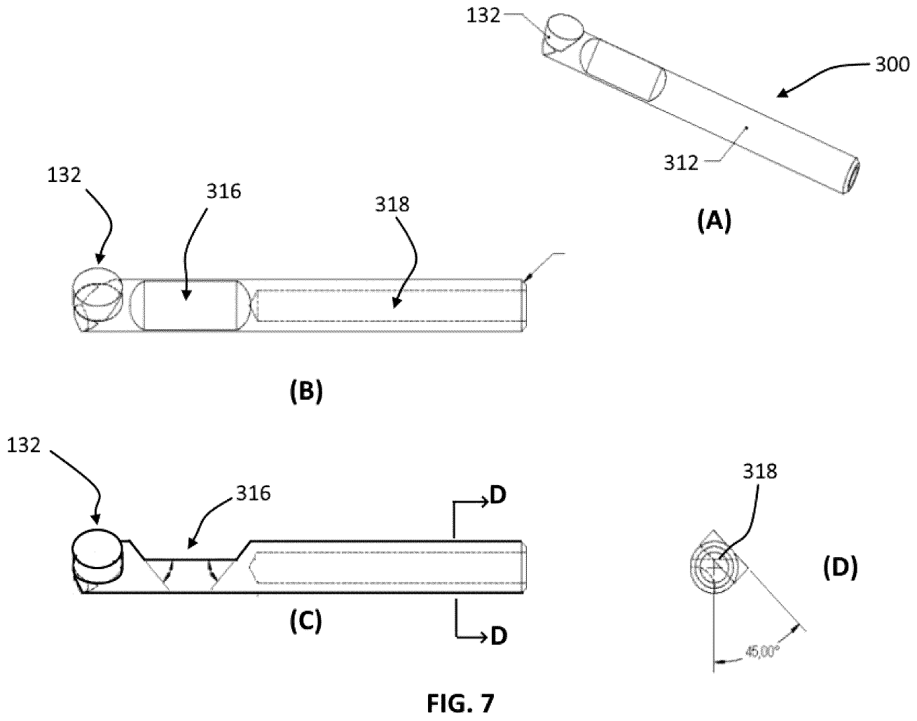

As shown on FIG. 6, the contacting head 132 is aligned with the gutter 316. Alternatively, as shown on FIG. 7, the contacting head 132 may be misaligned with the gutter 316 of an angle, preferably an angle of about 45 degrees. The orienting portion 340 may be angled towards the snowmobile 110 vis-à-vis the icy surface to maximize ice particles reaching components of the snowmobile 110.

FIGS. 6 to 11 shows different ways the ice scratching device 300 is connected to the securing element 320. In general, the first end 312 of the scratching device forms a tube having a longitudinal hole 318 configured to received the opposite end 326 of the coil 320 therein.

According to a preferred embodiment, the opposite end of the coil is affixed to the tube by welding or gluing.

According to a preferred embodiment, such as the one illustrated on FIG. 8, the tube 312 may have a lateral threaded hole 319 going through the tube's wall, the opposite end of the coil being affixed to the tube by screwing a screw in the hole.

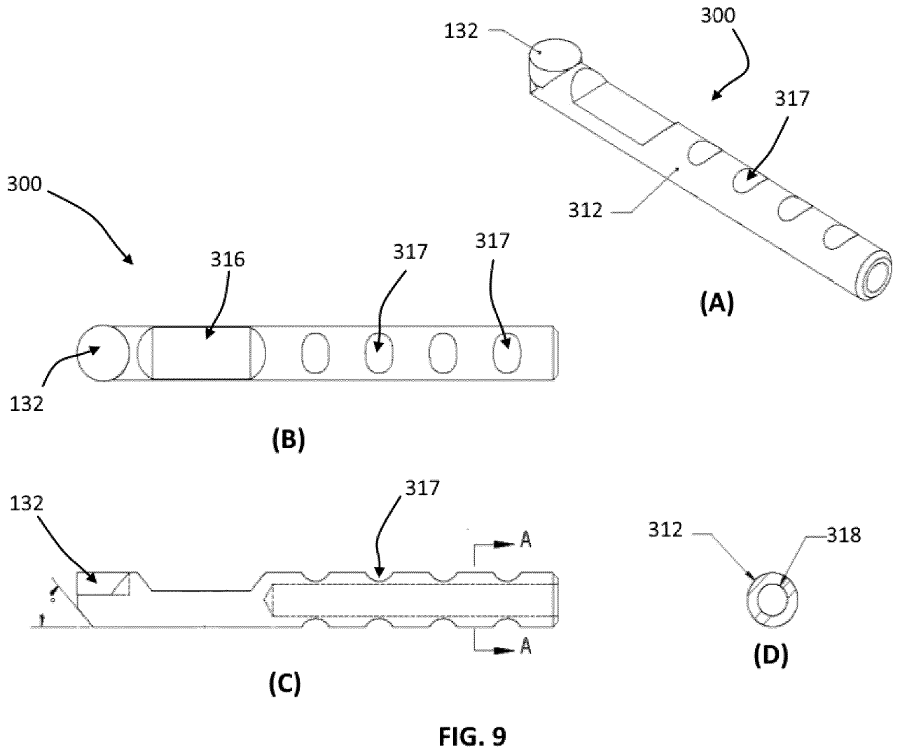

According to a preferred embodiment, such as the one illustrated on FIG. 9, the opposite end of the coil is affixed to the tube 312 by at least one pressing point 317 of the tube 312 towards the opposite end.

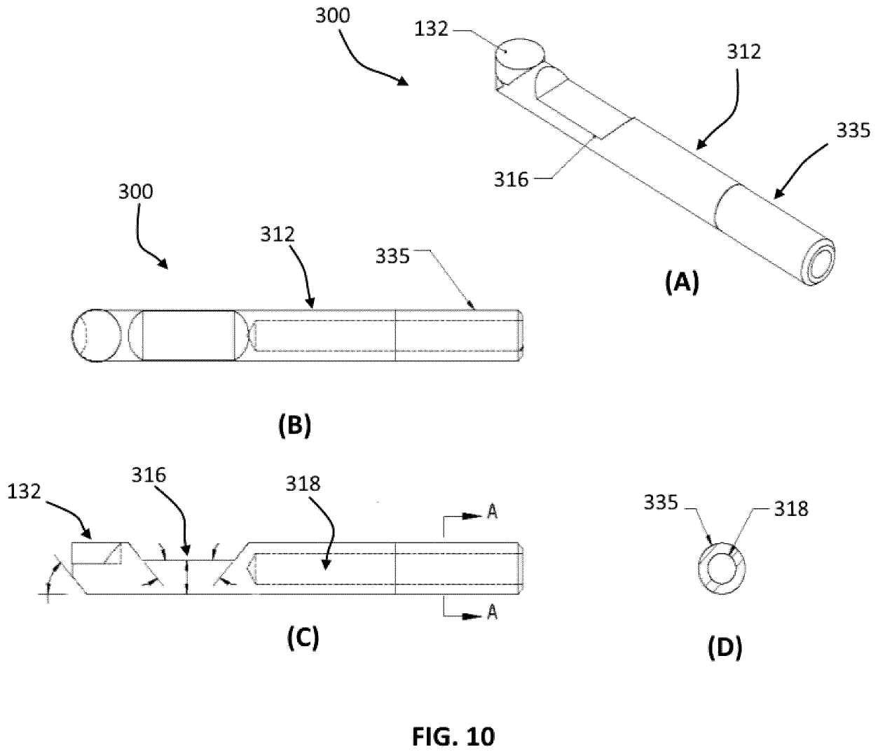

According to a preferred embodiment, such as the one illustrated on FIG. 10, the opposite end of the coil is affixed to another tube 335 configured to be secured to the tube 312 of the scratching device, for instance by screwing two matching threaded tubes.

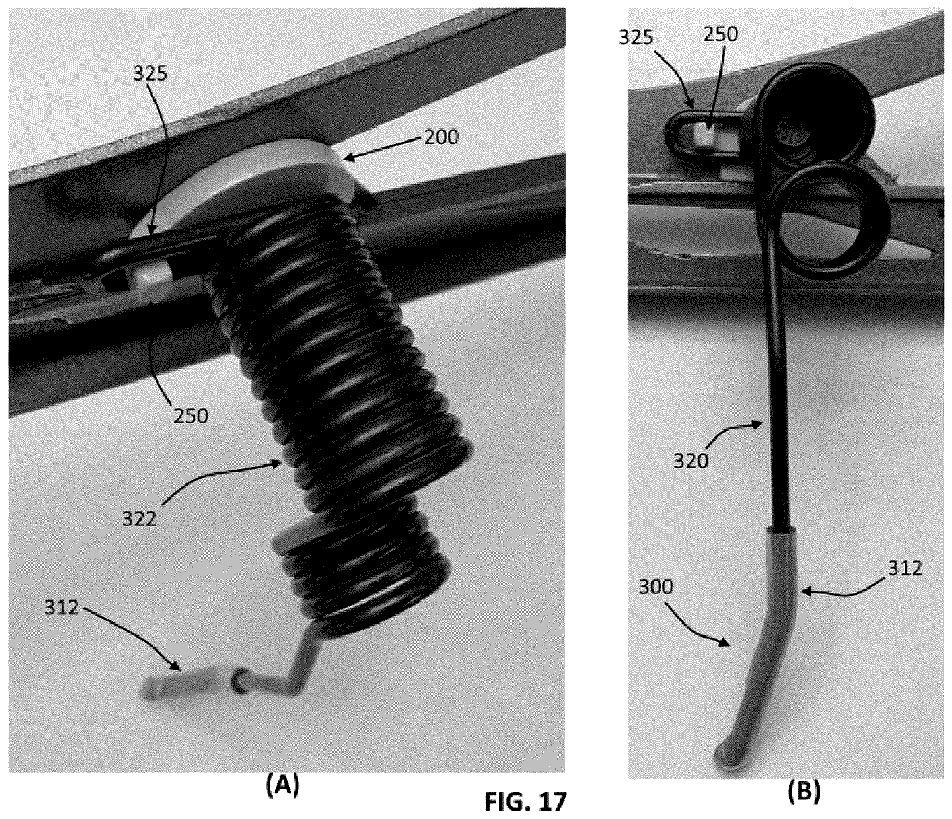

According to a preferred embodiment, such as the one illustrated on FIG. 11 or 17, the tube 312 may be curved for orienting the scratching device towards the snowmobile.

The securing portion 320 may comprise at least one spring element, preferably two springs as the one illustrated on FIGS. 16-18, having sufficient rigidity for allowing the scratching portion to apply a force directed on the icy surface that is capable of displacing enough ice particles to provide the stream of icy particles 116 to be directed by the orienting component 340 to cool and/or lubricate the snowmobile components.

The scratching head 132 may be provided in different shapes and sizes in order to address specific needs, such as the ones illustrated on FIG. 2B. The scratching head 132 may for example have a rounded shape, a square shape, a triangle shape, octagon shape, half-moon shape or may have a diamond tip shape. It is to be understood that these shapes are only examples and the scratching element 330 may be provided in additional shapes while still remaining within the teachings of the present invention.

The orienting component 340 may be provided with a variety of shapes and sizes according to the model of the snowmobile 110 and the location of the components to be cooled. As such, generic shapes may be produced for different snowmobile models but may also be custom-made according to specific requirements.

A downward force is exerted on the ice scratcher 300 which may be limited to the gravitational force or may be assisted by additional forces, for example, by forces generated by an interconnecting member secured to the snowmobile 110, depending on the configuration of the interconnecting member selected according to the model of the snowmobile 110. The interconnecting member may comprise a spring shaft configured to exert downward force onto the scratching portion 330 of the scratching device 300 . . . . When in use while the snowmobile 110 is travelling forward, the contacting head 332 of the scratching element 330 scratches the icy surface and detaches icy particles therefrom. The icy particles are detached considering the downward force and the movement of the snowmobile 110. The icy particles move in many directions upon detachment. The trajectory of the icy particles that are detached on an interior side of the ice scratcher 300 (i.e., between the ice scratcher 300 and the snowmobile 110) is affected by the orienting component 340 in order to provide the stream of icy particles 116 in a more controlled manner. More specifically, in the example of FIGS. 6 to 11, the orienting portion 340 comprises a gutter 316 with a substantially flat portion 316a between two inclined walls 316b, with an angle of about 40-50 degrees, preferably of about 48 degrees, forming a scoop. The icy particles detached by the contacting head 132 are directed upwards by the scoop thereby providing the stream of icy particles 116.

Skilled persons will readily recognize that the angle between the flat surface 316a and the walls 316b is not essential in all embodiments and that the selection of the angle therebetween shall take into consideration the type of distribution desired for the stream of icy particles 116 (e.g., a narrower angle limiting spread of the stream of icy particles 116 while a wider angle would expand the spread). It should also be understood that the direction of the stream of icy particles 116 is influenced by the manner in which the ice scratcher 300 is secured to the snowmobile 110 and, more specifically, by a rotational angle defined along the longitudinal axis of the ice scratcher 300; a downward angle defined between the longitudinal axis of the ice scratcher 300 and the icy surface as well as a transverse angle defined between the longitudinal axis of the snowmobile 110 and the longitudinal axis of the ice scratcher 300.

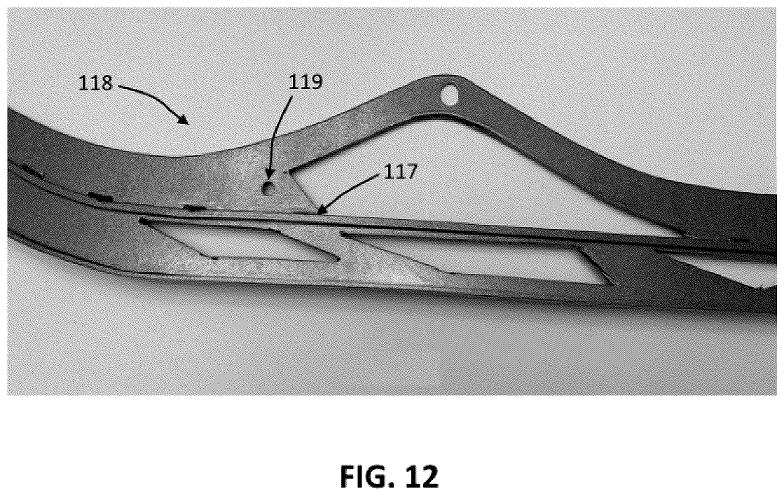

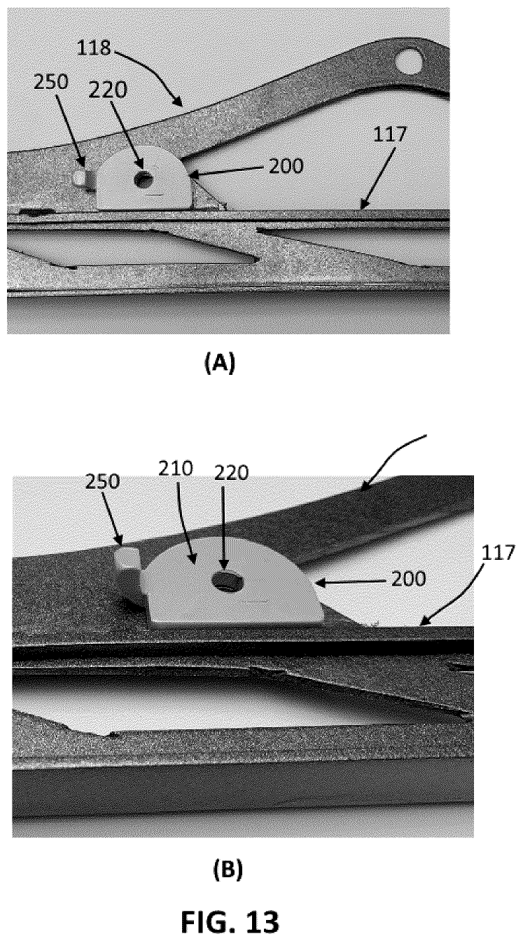

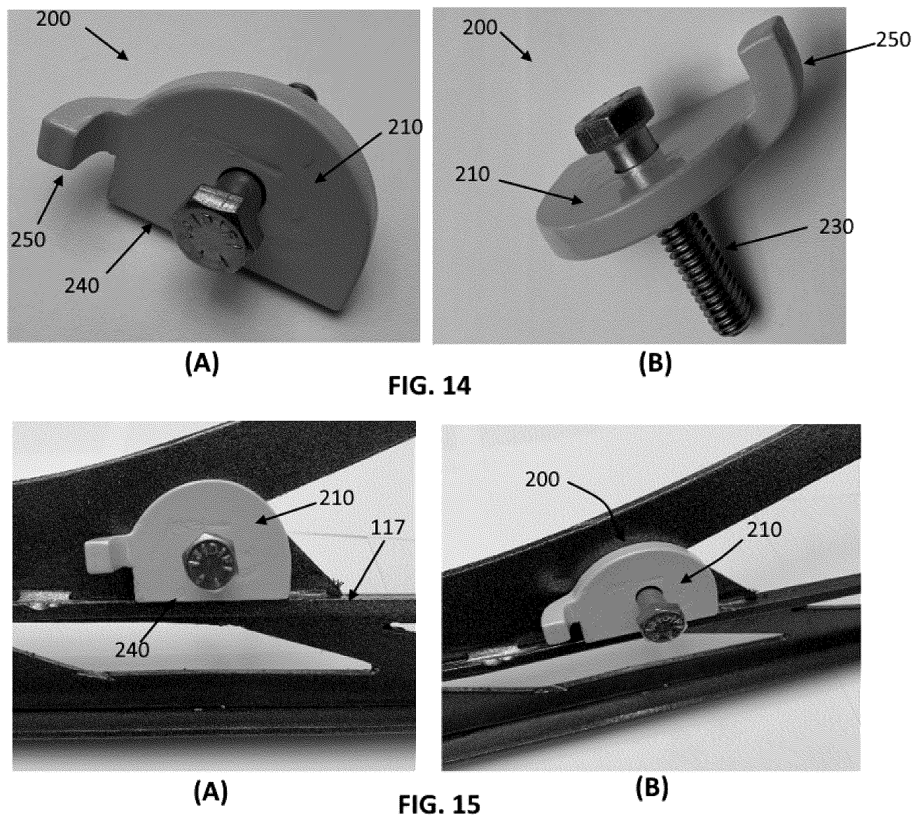

FIGS. 12 to 18 illustrate a novel equipment for fixing the securing element 320 comprising a coil, or a double coil as illustrated, to the frame 118 of a snowmobile. The lateral frame 118 is illustrated in part on FIG. 12. The frame has a hole 119 above and adjacent a longitudinal horizontal flange 117. A fixing element 200 is provided with a flat portion 210 having a hole 220 configured to match with the hole 119 of the frame 118 (FIGS. 13A and 13B) and to receive a fixing screw 230 (FIGS. 14A and 14B). The fixing element 200 has a straight edge 240 configured for being supported by the flange 117 of the frame when the fixing element is screwed to the frame (FIGS. 15A and 15B). The fixing element 200 also comprises a fixing pin 250 extending upwardly from the flat portion.

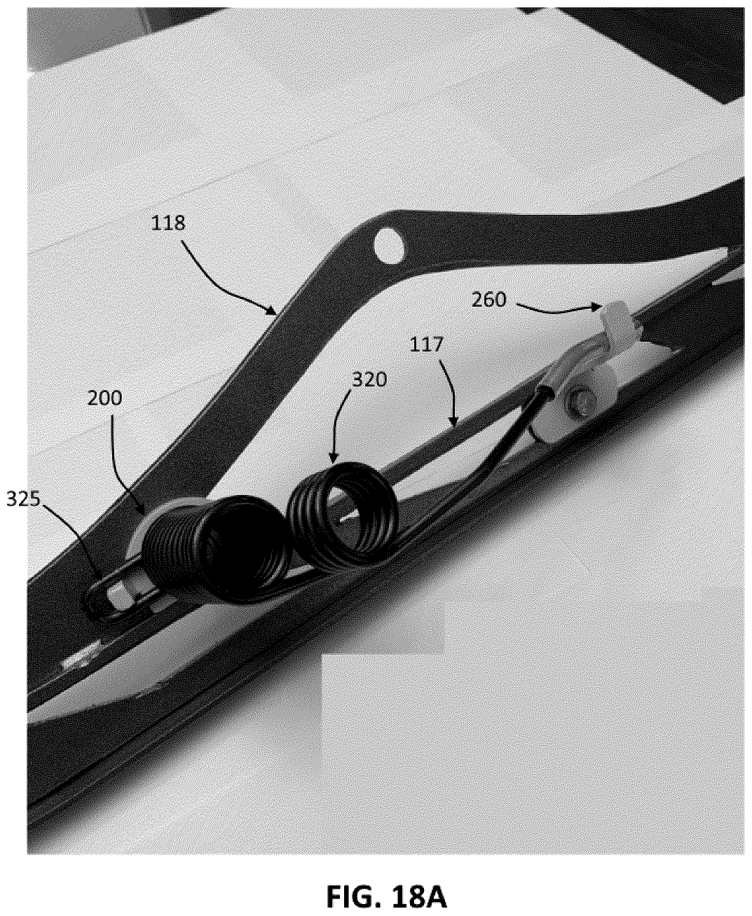

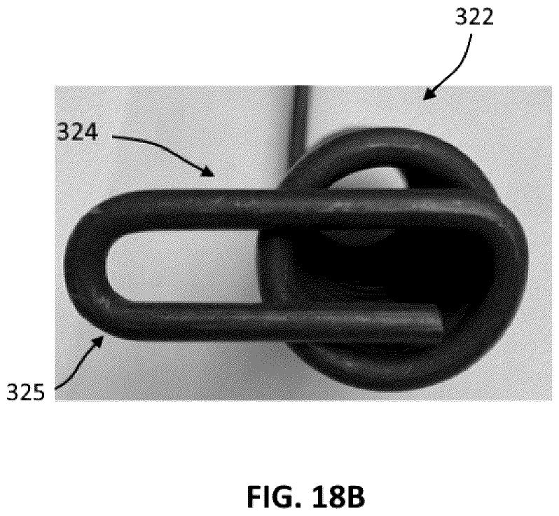

As illustrated on FIGS. 16 and 17, the coil or double-coil has one end 324 to be affixed at to the frame 118 of the snowmobile 110 and at an opposite end 326 connected to the scratching device 300. The one end 324 forms a boucle or longitudinal loop 325 (see FIG. 18B) configured for accepting the fixing pin 250 of the fixing element therein, and as such blocking a rotation of the coil around the screw 230 to the fixing element 200 when the coil 320 is screwed to the frame through the hole of the fixing element. FIGS. 16 and 17 show the securing element 320 in the active position for scratching the ice, whereas FIG. 18 shows the securing element 320 in a non-active position where the securing element 320 is maintained aligned with the flange 117 and maintained in this position with a hook 260 fixed to the frame.

Advantageously, the new fixing element 200 with its fixing pin 250 in conjunction with the loop 325 of the coil, and its straight edge 240 in conjunction with the flange 117 the frame 118, allows the ice starching device to be attached to the frame using a single hole through the frame, thus avoiding weakening the frame.

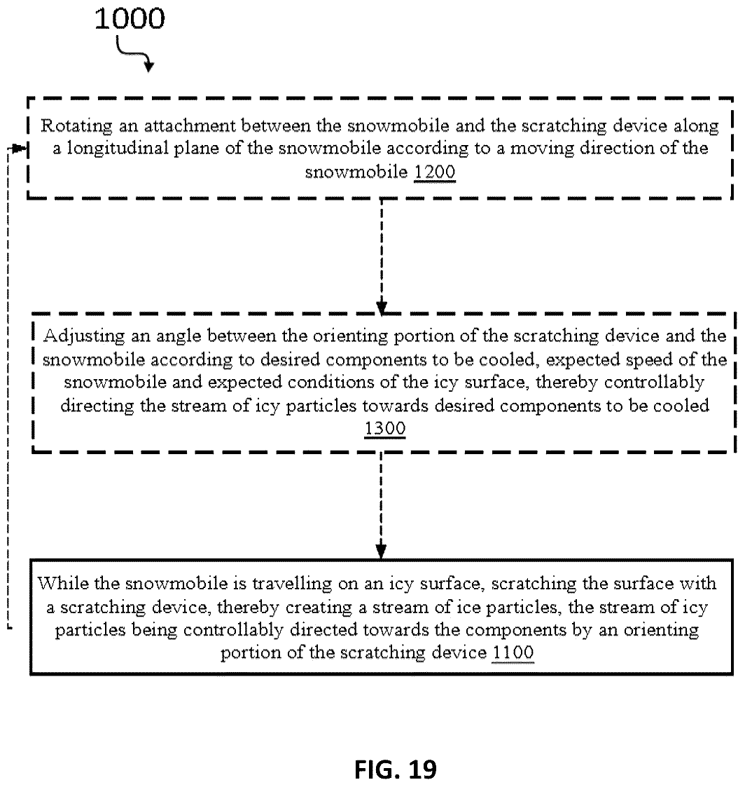

FIG. 19 shows a flow chart of an exemplary method 1000 for cooling components of a moving snowmobile. The method 1000 comprises, while the snowmobile is travelling on an icy surface, scratching 1100 the surface with a scratching device, thereby creating a stream of ice particles, the stream of icy particles being controllably directed towards the components by an orienting portion of the scratching device. Optionally, method 1000 may further comprise, before scratching 1100 (e.g., at the time of installation and/or before a snowmobile ride), rotating 1200 an attachment between the snowmobile and the scratching device along a longitudinal plane of the snowmobile according to a moving direction of the snowmobile. The method 1000 may also optionally further comprise adjusting 1300 an angle between the orienting portion of the scratching device and the snowmobile according to desired components to be cooled, expected speed of the snowmobile and expected conditions of the icy surface, thereby controllably directing the stream of icy particles towards desired components to be cooled.

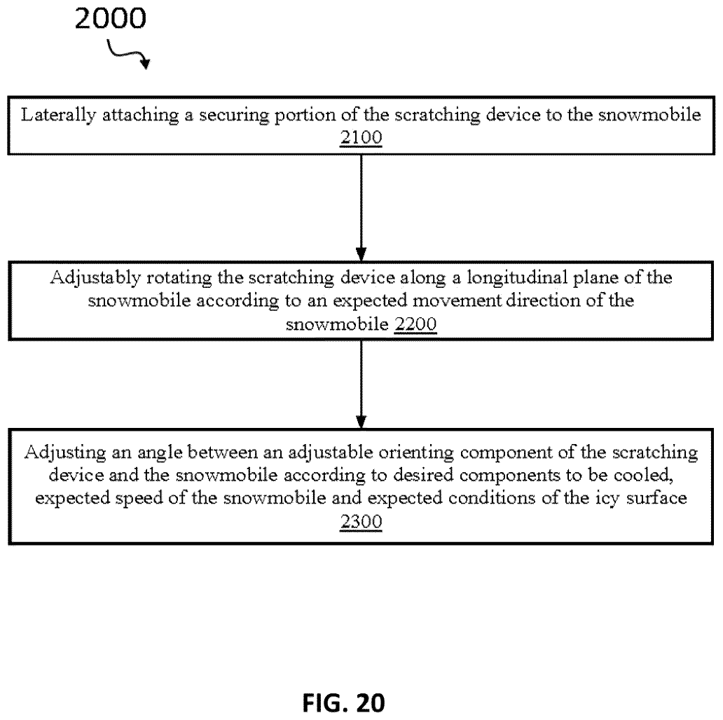

FIG. 20 shows an exemplary flow chart of a method 2000 of installing a scratching device on a snowmobile. The method comprises laterally attaching 2100 a securing portion of the scratching device to the snowmobile, adjustably rotating 2200 the scratching device along a longitudinal plane of the snowmobile according to an expected movement direction of the snowmobile and adjusting 2300 an angle between an orienting component of the scratching device and the snowmobile according to desired components to be cooled, expected speed of the snowmobile and expected conditions of the icy surface.

Although a snowmobile 110 has been presented herein, aspects of the present description could be applied to other types of tracked vehicles operating on snow or ice, such as snowbikes or all-terrain vehicles (ATVs), including three-wheel ATVs and motocross, provided with track and snow groomers.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A scratching device for a snowmobile, the device being configured to be operatively affixed to a securing element for laterally attaching the device towards the snowmobile, the scratching device comprising a scratching element for scratching an icy surface when the snowmobile is travelling on the icy surface, thereby creating a stream of ice particles, the scratching element comprising:
a contacting head for contacting the ice, and
an orienting portion adjacent the contacting head and configured to be affixed to the securing element,
wherein the orienting portion cooperates with the contacting head for orienting the stream of ice particles towards components the snowmobile that need to be cooled, and maximizing as such an amount of ice sent towards the components of the snowmobile when the snowmobile is travelling.

2. The scratching device of claim 1, wherein the contacting head and the orienting portion are permanently secured to one another, or the contacting head is removable from the scratching element.

3. The scratching device of claim 1, wherein the contacting head is made of a first material and the scratching portion is made of a second material, the first material being harder than the second material.

4. The scratching device of claim 1, wherein when the securing element is a flexible wire affixed at one end to the snowmobile and at the opposite end to the scratching device, the scratching element almost forms a triangular shape with a triangular surface and having:
a first edge configured to be aligned and affixed with the securing portion;
a second edge opposite the securing portion and forming a ridge extending perpendicularly from the triangular surface for defining the orienting portion;
a third edge extending from the securing portion, and
a recess defined at the junction of the second and third edges and configured for receiving and maintaining the contacting head therein.

5. The scratching device of claim 4, wherein the ridge forms a curved outside surface along the second edge, the orienting portion being angled towards the snowmobile vis-à-vis the icy surface.

6. The scratching device of claim 4, wherein the scratching device is hingely secured to the securing element towards the snowmobile for allowing rotation of the scratching device along a longitudinal plane of the snowmobile.

7. The scratching device of claim 1, wherein when the securing element is a coil affixed at one end to the snowmobile and at the opposite end to the scratching device, the scratching element has a longitudinal tubular shape with:
a first end configured to be aligned and affixed with the securing portion;
a second end opposite the first end and comprising the contacting head; and
a gutter adjacent the second end and forming the orienting portion.

8. The scratching device of claim 7, wherein the first end forms a tube configured to insert the opposite end of the coil therein, the opposite end of the coil being affixed to the tube by welding or gluing, or by pressing portions of the tube towards the opposite end.

9. The scratching device of claim 7, wherein the tube further defined a lateral threaded hole, the opposite end of the coil being secured to the tube by screwing a screw in the hole.

10. The scratching device of claim 7, wherein the opposite end of the coil is affixed to another tube configured to be secured to the tube of the scratching device by screwing.

11. The scratching device of claim 7, wherein the tube is curved.

12. The scratching device of claim 7, wherein the coil is a double coil.

13. The scratching device of claim 7, wherein the contacting head is misaligned with the gutter of an angle.

14. The scratching device of claim 13, wherein the angle is about 45°.

15. The scratching device of claim 7, wherein the coil has one end to be affixed at to a frame of the snowmobile and at an opposite end connected to the scratching device, the one end forms a boucle or longitudinal loop configured for accepting a fixing pin of the fixing element therein for blocking a rotation of the coil around a screw to the fixing element when the coil is screwed to the frame through an orifice of the fixing element.

16. The scratching device of claim 1, wherein the snowmobile comprises a longitudinal axis defined by a rear end and a front end of the snowmobile such that:
the scratching device is positioned behind the securing portion when the snowmobile is in forward movement and positioned in front of the securing portion when the snowmobile is in rearward movement; or
the scratching device is positioned in front the securing portion when the snowmobile is in forward movement and positioned behind of the securing portion when the snowmobile is in rearward movement.

17. A method for cooling components of a moving snowmobile comprising:
while the snowmobile is travelling on an icy surface, scratching the surface with the scratching device as claimed in claim 1, thereby creating a stream of ice particles, the stream of icy particles being controllably directed towards the components by an orienting portion of the scratching device.

18. The method of claim 17, further comprising rotating an attachment between the snowmobile and the scratching device along a longitudinal plane of the snowmobile according to a moving direction of the snowmobile.

19. The method of claim 17, further comprising adjusting an angle between the orienting portion of the scratching device and the snowmobile according to desired components to be cooled, expected speed of the snowmobile and expected conditions of the icy surface, thereby controllably directing the stream of icy particles towards desired components to be cooled.

20. A method of installing a scratching device on a snowmobile, the scratching device being as claimed in claim 1, the method comprising:
laterally attaching the securing element to the scratching device and to the snowmobile,
adjustably rotating the scratching device along a longitudinal plane of the snowmobile according to an expected movement direction of the snowmobile, and
adjusting an angle between an orienting portion of the scratching device and the snowmobile according to desired components to be cooled, expected speed of the snowmobile and expected conditions of the icy surface.
